(19) United States
(12) Patent Application Publication
(10) Pub. No.: US 2025/0342992 A1
(43) Pub. Date: Nov. 6, 2025

(54) MAGNETIC MATERIAL AND METHOD FOR PRODUCING MAGNETIC MATERIAL

(71) Applicant: Murata Manufacturing Co., Ltd., Kyoto-fu (JP)

(72) Inventors: Mitsuru ODAHARA, Nagaokakyo-shi (JP); Yuudai NAKAE, Nagaokakyo-shi (JP); Akira OKUMURA, Nagaokakyo-shi (JP); Mikito SUGIYAMA, Nagaokakyo-shi (JP)

(73) Assignee: Murata Manufacturing Co., Ltd., Kyoto-fu (JP)

(21) Appl. No.: 19/266,413

(22) Filed: Jul. 11, 2025

Related U.S. Application Data
(63) Continuation of application No. PCT/JP2024/003685, filed on Feb. 5, 2024.

(30) Foreign Application Priority Data
Feb. 10, 2023 (JP) 2023-019455

(51) Int. Cl. H01F 1/22; B22F 1/05; B22F 1/17; B22F 3/10; C22C 38/10; H01F 27/24; H01F 27/28; H01F 41/02

(52) U.S. Cl. CPC H01F 1/22; B22F 1/05; B22F 1/17; B22F 3/10; C22C 38/105; H01F 27/24; H01F 27/28; H01F 41/02; B22F 2301/35; B22F 2304/10; B22F 2998/10; B22F 2999/00; C22C 2202/02

(57) ABSTRACT

A magnetic material that is a sintered body including a plurality of metal magnetic particles having a grain boundary phase. The grain boundary phase contains a metal oxide or a metal nitride that is an oxide or a nitride of a nonmagnetic metal. The metal magnetic particles have an equivalent circle diameter of 0.29 μm or more and 2.33 μm or less (i.e., from 0.29 μm to 2.33 μm).

### CROSS-REFERENCE TO RELATED APPLICATIONS

This application claims benefit of priority to International Patent Application No. PCT/JP2024/003685, filed Feb. 5, 2024, and to Japanese Patent Application No. 2023-019455, filed Feb. 10, 2023, the entire contents of each are incorporated herein by reference.

### BACKGROUND

### Technical Field

The present disclosure relates to a magnetic material and a method for producing a magnetic material.

### Background Art

There are cases where composite magnetic materials are used as magnetic materials for applications such as magnetic components. One such composite magnetic material includes a resin containing a material such as a soft magnetic powder composed of powder particles dispersed therein as described, for example, in Japanese Unexamined Patent Application Publication No. 2016-143827.

### SUMMARY

If a composite magnetic material includes a resin, a current flowing through a magnetic component including an element body including the magnetic material and wiring causes a magnetic flux to be locally concentrated between the powder particles of the soft magnetic powder in the magnetic material, which may increase eddy current loss and degrade high-frequency characteristics.

Accordingly, the present disclosure provides a magnetic material and a method for producing the magnetic material that can achieve improved high-frequency characteristics.

That is, the present disclosure provides a magnetic material that is a sintered body including a plurality of metal magnetic particles having a grain boundary phase. The grain boundary phase contains a metal oxide or a metal nitride that is an oxide or a nitride of a nonmagnetic metal, and the metal magnetic particles have an equivalent circle diameter of 0.29 μm or more and 2.33 μm or less (i.e., from 0.29 μm to 2.33 μm).

Also, the present disclosure provides a method for producing a magnetic material, including forming a sintered body including a plurality of metal magnetic particles. A grain boundary phase is formed between the plurality of metal magnetic particles at least upon completion of sintering, and the grain boundary phase contains a metal oxide or a metal nitride that is an oxide or a nitride of a nonmagnetic metal.

According to the present disclosure, improved high-frequency characteristics can be achieved.

### BRIEF DESCRIPTION OF THE DRAWINGS

FIG. 1 is a partial enlarged sectional view schematically illustrating the structure of a magnetic material of the present disclosure;

FIG. 2 is a partial enlarged sectional view of a portion in dotted-line circle in FIG. 1;

FIG. 3 is a perspective view schematically illustrating an electronic component including the magnetic material of the present disclosure;

FIG. 4 is a schematic sectional view taken along line a-a in FIG. 3; and

FIG. 5 is a perspective view schematically illustrating an electronic component according to another embodiment.

### DETAILED DESCRIPTION

A magnetic material according to an embodiment of the present disclosure will be described below with reference to the drawings. Although reference is made to the drawings for description when necessary, the details illustrated in the drawings are schematic and given by way of example only for an understanding of the present disclosure, and the appearance, the dimensional ratio, and the like may differ from those of actual products.

FIG. 1 is a partial enlarged sectional view schematically illustrating the structure of the magnetic material of the present disclosure.

A magnetic material in the related art that includes a soft magnetic powder dispersed in a resin may exhibit degraded high-frequency characteristics; therefore, the present inventor has conducted intensive studies on and conceived a novel magnetic material that differs in configuration from the magnetic material in the related art.

Specifically, as illustrated in FIG. 1, a magnetic material 11α of the present disclosure is a sintered body including a plurality of metal magnetic particles 11A having a grain boundary phase 11B. Since the plurality of metal magnetic particles 11A are arranged in close contact with each other, the grain boundary phase 11B can be formed at a boundary portion between one metal magnetic particle 11A and another metal magnetic particle 11A adjacent thereto.

In the present disclosure, the grain boundary phase 11B contains a metal oxide or a metal nitride that is an oxide or a nitride of a nonmagnetic metal. The grain boundary phase 11B may contain an oxide of the metal magnetic particles 11A.

When the grain boundary phase 11B takes the above form, the metal oxide or the metal nitride can be provided in contact with the metal magnetic particles 11A and covers the surfaces of the metal magnetic particles 11A.

Because the metal oxide or the metal nitride is an oxide or a nitride of a nonmagnetic metal, the metal oxide or the metal nitride can have a higher electrical resistivity than the metal magnetic particles. For example, the metal oxide or the metal nitride can have an electrical resistivity of 1×10\hat{ }11 Ω·cm or more and 1×10\hat{ }16 Ω·cm or less (i.e., from 1×10\hat{ }11 Ω·cm to 1×10\hat{ }16 Ω·cm). In addition, the metal magnetic particles can have an electrical resistivity of 0.089 μΩ·m or more and 1.76 μΩ·m or less (i.e., from 0.089 μΩ·m to 1.76 μΩ·m). In addition, the metal oxide or the metal nitride itself can be nonmagnetic.

Thus, the grain boundary phase 11B can function as a high-resistivity portion compared to the metal magnetic particles 11A. To improve this function, the metal oxide or the metal nitride of the grain boundary phase 11B preferably covers the entire surfaces of the metal magnetic particles 11A.

As described later, when an element body of an electronic component includes the magnetic material 11α of the present disclosure, the high-resistivity portion can increase the electrical resistance of the path of an eddy current flowing through the magnetic material (corresponding to a sintered body) of the element body, thereby reducing eddy current loss. Because the eddy current loss becomes larger as the current frequency becomes higher, the high-frequency characteristics can be improved by reducing the eddy current loss.

Furthermore, in the present disclosure, the metal magnetic particles 11A have an equivalent circle diameter of 0.29 μm or more and 2.33 μm or less (i.e., from 0.29 μm to 2.33 μm). When an element body of an electronic component includes the magnetic material 11α of the present disclosure, the metal magnetic particles 11A preferably have an equivalent circle diameter of 0.29 μm or more as mentioned above from the viewpoint of preventing formation of an oxide of an Fe component contained in the metal magnetic particles 11A in the magnetic material (corresponding to a sintered body) of the element body. In addition, the metal magnetic particles 11A preferably have an equivalent circle diameter of 2.33 μm or less as mentioned above from the viewpoint of reducing the likelihood that the equivalent circle diameter exceeds the skin depth at 200 MHz, which is assumed for next-generation inductors.

In addition, the metal magnetic particles 11A can contain Fe, and the metal oxide or the metal nitride that is the oxide the nitride can be at least one selected from the group consisting of Si, Al, Cr, Ca, Mg, Ti, Mn, V, Zr, Nb, and Ta, the at least one being an element that oxidizes more easily than Fe. In the present disclosure, Si, which is generally known as a metalloid, is regarded as a metal element.

In addition, the filling factor of the plurality of metal magnetic particles 11A in the magnetic material 11α of the present disclosure is preferably 66.7% or more from the viewpoint of ensuring magnetic permeability, that is, from the viewpoint of ensuring a suitable inductance value (L value), and is preferably 95.1% or less from the viewpoint of reducing the eddy current loss.

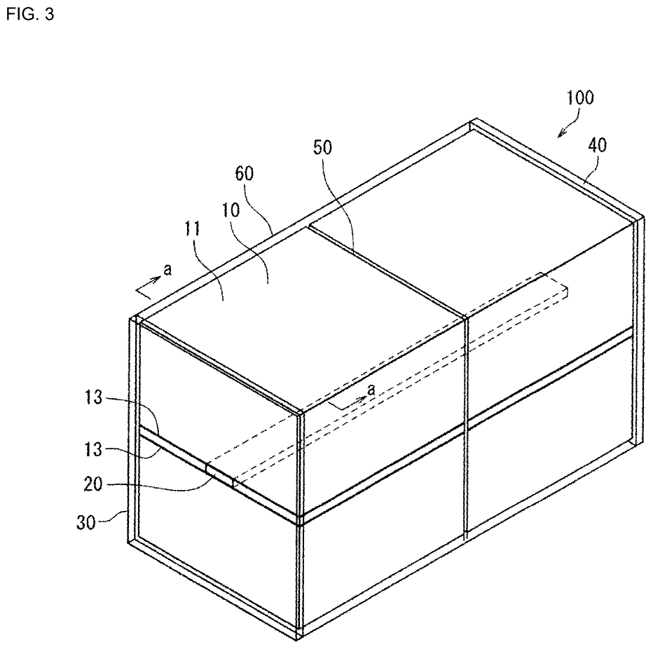

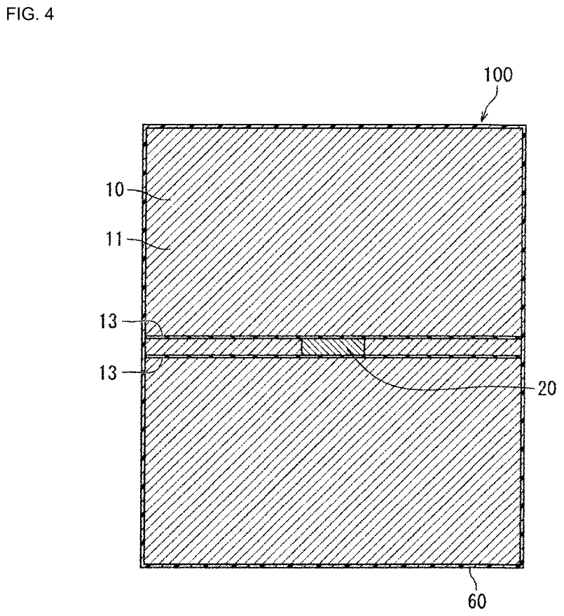

FIG. 3 is a perspective view schematically illustrating an electronic component including the magnetic material of the present disclosure. FIG. 4 is a schematic sectional view taken along line a-a in FIG. 3.

As illustrated in FIGS. 3 and 4, an electronic component 100 includes an element body 10 including a magnetic material 5 of the present disclosure, wiring 20, and outer electrodes 30 and 40. Because the element body 10 includes the magnetic material 5 of the present disclosure, the element body 10 includes a sintered body 11. The sintered body 11 itself includes at least one metal magnetic sintered layer. As one example, the element body 10 can have a hexahedral structure. An insulating covering layer 60 covering the surface of the element body 10 excluding the outer electrodes 30 and 40 can also be formed.

When metal magnetic layers having the same composition are continuously stacked on top of each other in the sintered body 11, it is difficult to find the boundaries between the metal magnetic layers. Accordingly, even when a sintered body includes a plurality of metal magnetic layers stacked on top of each other, they are regarded as a single sintered body if no first insulating layer, described later, is located therebetween. In addition, even when a plurality of metal magnetic layers having different compositions are stacked on top of each other and can be distinguished from each other, they are regarded as a single sintered body as long as no first insulating layer, described later, is located therebetween.

As one example, the wiring 20 can be provided in the element body 10. The wiring 20 is formed of a conductive material. For example, at least one conductive material can be selected from the group consisting of silver, copper, aluminum, and the like. As one example, the wiring 20 can be in the form of straight wiring as illustrated in FIG. 3. The wiring 20 is not limited thereto and can be coil-shaped wiring. The outer electrodes 30 and 40 are provided on the surface of the element body 10. These outer electrodes 30 and 40 are connected to both ends of the wiring 20 and are disposed opposite and at a distance from each other with the element body 10 interposed therebetween.

Because the element body 10 includes the magnetic material 5 of the present disclosure, the element body 10 includes a metal oxide or a metal nitride with relatively high resistivity. Thus, the electrical resistance of the path of an eddy current flowing through the sintered body 11 of the element body 10 can be increased, thereby reducing eddy current loss. Because the eddy current loss becomes larger as the current frequency becomes higher, the high-frequency characteristics can be improved by reducing the eddy current loss.

As illustrated in FIGS. 3 and 4, the element body 10 can further include a first insulating layer 13 in addition to the sintered body 11. In the present disclosure, the high-resistivity portion provided in the grain boundary phase between the metal magnetic particles 11A contained in the magnetic material forming the sintered body 11 of the element body 10 ensures insulation between the metal magnetic particles. Thus, ensures insulation and eddy current loss can be reduced without necessarily using the first insulating layer 13, and good high-frequency characteristics in the 200 MHz band for next-generation inductors can be achieved.

The first insulating layer 13 can extend continuously in layer form from one side to the other side of the sintered body 11 in a direction intersecting a stacking direction L. When the first insulating layer 13 takes this form, two or more sintered bodies 11 separated by the first insulating layer 13 can be provided.

In this case, the element body 10 can include the two or more sintered bodies 11 and the first insulating layer 13, and one sintered body 11 and another sintered body adjacent thereto can be stacked on top of each other with the first insulating layer 13 interposed therebetween. The presence of the first insulating layer 13 can provide a magnetic gap function compared to the absence of the first insulating layer 13. In addition, the first insulating layer 13 is preferably nonmagnetic. This allows the direct-current superimposition characteristics to be improved due to a decrease in the magnetic permeability of the element body 10. The first insulating layer 13 is not limited thereto and can be a low-magnetic-permeability insulating layer having a lower magnetic permeability than the sintered body 11, rather than a nonmagnetic insulating layer. In this case, the inductance can also be improved compared to a nonmagnetic insulating layer.

Wiring 20 covered with an insulator may be provided. In this structure, the portion of the wiring 20 other than both ends connected to the outer electrodes 30 and 40 is directly surrounded by the insulator. This allows the insulator to function as a magnetic gap. In addition, the insulator is preferably nonmagnetic.

This allows the direct-current superimposition characteristics to be improved due to a decrease in the magnetic permeability of the element body 10. The insulator is not limited thereto and can be a low-magnetic-permeability insulator having a lower magnetic permeability than the sintered body 11, rather than a nonmagnetic insulator. In this case, the inductance can also be improved compared to a nonmagnetic insulator.

Two or more first insulating layers 13 can be provided at a distance from each other. In the form illustrated in FIGS. 3 and 4, the element body 10 includes four sintered bodies 11. In this case, the wiring 20 can be disposed between the first insulating layers 13, and the element body 10 can include three or more sintered bodies 11. In addition, when two or more first insulating layers 13 are provided, a multilayer structure in which the sintered bodies 11 and two or more the first insulating layers 13 are alternately stacked on top of each other can be formed. The presence of two or more first insulating layers 13 provides a greater magnetic gap function, and when each insulating layer 13 has a lower magnetic permeability than the sintered bodies 11, the direct-current superimposition characteristics can be further improved.

In addition, as illustrated in FIGS. 3 and 4, when the element body 10 includes two or more sintered bodies 11, the first outer electrode 30 and the second outer electrode 40 are disposed on the surfaces of different sintered bodies 11. In this arrangement of the outer electrodes 30 and 40, the element body 10 can further include a second insulating layer 50.

Specifically, the first outer electrode 30 and the second outer electrode 40 are disposed on the surfaces of adjacent sintered bodies 11. The first outer electrode 30 is disposed on the surface of the sintered body 11 on one side, whereas the second outer electrode 40 is disposed on the surface of the sintered body 11 on the other side. In this configuration, the second insulating layer 50 can be disposed between the sintered body 11 on which the first outer electrode 30 is disposed and the sintered body 11 on which the second outer electrode 40 is disposed. The presence of the second insulating layer 50 can prevent a short circuit between the first outer electrode 30 and the second outer electrode 40.

As one example, the second insulating layer 50 can be disposed in a form in which the second insulating layer 50 extends in a direction intersecting the direction in which the first insulating layer 13 extends, for example, in a direction perpendicular to the first insulating layer 13, and can be a slit-shaped tangible object. The second insulating layer 50 is not disposed so as to extend into and divide the wiring located inside the element body 10.

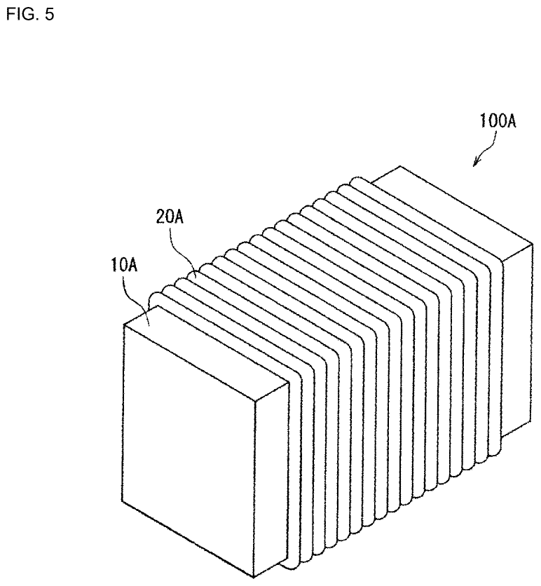

In the present disclosure, the wiring need not be disposed inside the element body. As illustrated in FIG. 5, wiring 20A may be disposed in a state in which the wiring 20A is wound around the outside of an element body 10A.

A method for manufacturing the electronic component of the present disclosure will be described below.

### <Step of Preparing Metal Magnetic Particles>

First, metal magnetic particles containing an Fe component (e.g., FeNiCo-based particles) are provided. Next, in one embodiment, a sol-gel process is performed in which a slurry is prepared by mixing a metal alkoxide containing a nonmagnetic metal element that oxidizes more easily than Fe with a solvent (e.g., water or an alcohol) and the alkoxide in the slurry is hydrolyzed. The slurry is then dried to obtain metal magnetic particles having the surfaces thereof covered with a coating film containing the element that oxidizes more easily than Fe. In this process, a second coating film may be further formed on the first coating film by using a metal alkoxide containing a nonmagnetic metal element different from the nonmagnetic metal material used for the first coating film. The coating film may be composed of one layer, two layers, or three or more layers.

The metal alkoxide is represented by the chemical formula M(OR)ₓ (M: nonmagnetic metal element, OR: alkoxy group). The metal species M forming the metal alkoxide may be at least one selected from the group consisting of Si, Al, Cr, Ca, Mg, Ti, Mn, V, Zr, Nb, and Ta. The metal alkoxide is preferably, but not particularly limited to, an alkoxide of at least one selected from the group consisting of Si, Ti, Al, and Zr. In the present specification, Si, which is generally known as a metalloid, is regarded as a metal element.

When the metal alkoxide is an alkoxide of at least one selected from the group consisting of Si, Ti, Al, and Zr, a metal oxide having higher strength and higher resistivity can be formed.

The alkoxy group OR forming the metal alkoxide is not particularly limited and may be, for example, an alkoxy group having 10 or less carbon atoms, particularly 5 or less carbon atoms, more particularly 3 or less carbon atoms. Fewer carbon atoms allow the hydrolysis reaction to proceed more easily. The alkoxy group is preferably, for example, at least one selected from the group consisting of a methoxy group, an ethoxy group, and a propoxy group.

Specifically, the metal alkoxide is preferably at least one selected from the group consisting of tetraethyl orthosilicate, titanium tetraisopropoxide, zirconium-n-butoxide, and aluminum isopropoxide.

The slurry may contain a water-soluble polymer. The water-soluble polymer can be at least one selected from the group consisting of polyvinylpyrrolidone, polyvinyl alcohol, hydroxypropyl cellulose, poly(2-methyl-2-oxazoline), polyethyleneimine, polyacrylic acid, and carboxymethyl cellulose.

Without being limited to the sol-gel process, a coating film containing an element that oxidizes more easily than Fe may be formed on the surfaces of the metal magnetic particles. In addition, the metal magnetic particles themselves may have a composition further containing an element that oxidizes more easily than Fe. Furthermore, a metal nitride component may be provided on the surfaces of the metal magnetic particles. In addition, instead of forming a coating film containing an element that oxidizes more easily than Fe, a metal nitride component of a nonmagnetic metal may be provided on the surfaces of the metal magnetic particles in advance. Also in this case, the sintered metal nitride component remains in the grain boundary phase and has high electrical resistivity. The metal oxide and the metal nitride of the nonmagnetic metal are, of course, nonmagnetic.

### <Step of Preparing Metal Magnetic Paste>

After the preparation of the metal magnetic particles, the metal magnetic particles are mixed with other materials such as a varnish and a solvent (e.g., terpineol) using a stirrer. The mixture is then dispersed in a roll mill to obtain a metal magnetic paste.

### <Step of Preparing Insulating Paste>

Nonmagnetic insulating particles are provided. The insulating particles are then mixed with other materials such as a varnish and a solvent (e.g., terpineol) using a stirrer. The mixture is then dispersed in a roll mill to obtain an insulating paste. The nonmagnetic insulator used for the insulating paste can be, for example, a mixture of alumina, silica, glass, or a dielectric material such as calcium zirconate, strontium zirconate, and/or barium zirconate with borosilicate glass or the like.

### <Step of Preparing Wiring Paste>

Conductive particles are mixed with other materials such as a varnish and a solvent (e.g., terpineol) using a stirrer. The mixture is then dispersed in a roll mill to obtain a wiring paste. Conductive particles such as copper particles or silver particles can be selected.

### <Step of Preparing Unfired Multilayer Body>

After the preparation of the individual pastes, a metal magnetic layer having a predetermined thickness is formed by screen printing or the like using the metal magnetic paste and is dried. After drying, a slit groove having a predetermined width is formed by laser processing and is filled with the insulating paste by screen printing or the like, and the insulating paste is dried. The slit groove is not limited to one formed by post-processing using laser processing, and its pattern may be formed in advance using a screen printing plate or the like.

After the filling of the slit groove with the insulating paste and drying, an insulating layer having a predetermined thickness is formed on the metal magnetic layer by screen printing using the insulating paste and is dried. The type of insulating paste used to form the insulating layer may be different from the type of insulating paste used to fill the slit groove.

Wiring having the desired shape (e.g., a straight shape, a coil shape, or a meandering shape) is formed on the insulating layer by screen printing using the wiring paste. After the formation of coil wiring, an insulating layer may be further formed thereon. The formation of the metal magnetic layer and optionally the formation of the insulating layer as described above are repeatedly performed to obtain an unfired multilayer body.

If the resulting electronic component has an L value higher than the desired value, fewer or no insulating layers may be formed. This allows the balance between the L value and the direct-current superimposition characteristics to be adjusted. Although screen printing layers formed by screen printing are stacked on top of each other in the method described above, the electronic component is not limited thereto and may be produced by a method in which sheets are prepared in a separate step and are stacked on top of each other.

<Step of Cutting into Piece and Firing Unfired Multilayer Body>

The unfired multilayer body is cut into a piece using a dicer or the like. The piece is then debinded in a nitrogen atmosphere in a firing furnace, followed by firing in a reducing atmosphere containing 3% of H₂ and 97% of N₂ at a temperature of 900° C. or higher and 1,000° C. or lower (i.e., from 900° C. to 1,000° C.) for a predetermined time (e.g., 1 hour). Thus, a sintered multilayer body including a sintered body having a high-resistivity portion therein and an insulating layer can be obtained.

The high-resistivity portion in the resulting sintered body can contain an oxide or a nitride of an element that oxidizes more easily than Fe. The method may also be configured such that an element that oxidizes less easily than Fe is oxidized in a different step before being contained in the high-resistivity portion after firing.

In addition, although it is assumed that a nonmagnetic insulating layer is formed in the method described above, a low-magnetic-permeability insulating layer that is slightly magnetic may be obtained by allowing the metal magnetic component to diffuse from the metal magnetic layers into the nonmagnetic insulating layer, for example, by increasing the retention time at the maximum temperature during the firing.

### <Formation of Outer Electrodes>

Subsequently, the outer surface of the sintered body is optionally coated with an insulating resin or the like, and the coating is removed from regions where the wiring is to be connected to outer electrodes using a laser or the like. The sintered body is then plated to form outer electrodes. Finally, an electronic component of the present disclosure is obtained. The material for the outer electrodes can be, for example, silver.

### EXAMPLES

Examples of the present disclosure will be described below.

### <Acquisition of Filling Factor of Metal Magnetic Particles in Sintered Body>

Each fired sample is placed in liquid resin and the resin is cured, is polished with a Tegramin-25 polishing device (manufactured by Struers), and is subjected to ion milling with an IM-3000 ion milling device (manufactured by Hitachi High-Technologies Corporation). An SEM image and optionally an element mapping image are then acquired under an SU8230 field-emission scanning electron microscope (manufactured by Hitachi High-Technologies Corporation). These acquired images can be analyzed with WinROOF 2021 image analysis software (manufactured by Mitani Corporation) to calculate the filling factor of the metal magnetic particles. When sintered toroidal core is used for calculation, the filling factor is calculated as the average of analysis values at a total of three positions including three randomly selected positions near ½ of the thickness of the sintered toroidal core. When the finally obtained electronic component is used for calculation, the filling factor is calculated as the average of analysis values at a total of six positions including three randomly selected positions located 1 time the wiring thickness upward from the uppermost surface of the inner wiring and three randomly selected positions located 1 time the wiring thickness downward from the lowermost surface of the inner wiring. In the present disclosure, “the filling factor of the metal magnetic particles in the sintered body” is expressed as the proportion of the area of the metal magnetic particles relative to the area of the sintered body including voids.

### <Ollendorff Approximation Formula>

The Ollendorff approximation formula is an approximation formula for theoretically deriving the relative magnetic permeability μη for the filling factor η of the metal magnetic particles. The Ollendorff approximation formula was used to calculate the filling factor of the desired metal magnetic particles at 200 MHz as follows. From the Ollendorff approximation formula, where η is the filling factor of the metal magnetic particles, μ is the relative magnetic permeability, and N is the demagnetization field coefficient, the relative magnetic permeability μη for the filling factor η is expressed by equation 1 below.

$$μη = \frac{η ( μ - 1 )}{N ( 1 - η ) ( μ - 1 ) + 1} + 1 \qquad [ Equation 1 ]$$

Here, the μ of Fe10Ni20Co was 70, and N was 0.1, which is equivalent to a sphere. The drive frequencies of DC-DC converters are assumed to increase to about 200 MHz in future; therefore, it is desirable that μη be 15 or more and 50 or less (i.e., from 15 to 50) at a frequency of 200 MHz. The filling factor η with which this μη can be obtained is calculated to be 66.7% or more and 95.1% or less (i.e., from 66.7% to 95.1%) from the above equation.

When an electronic component including a sintered body of the present disclosure is actually manufactured, the electronic component can be manufactured by the following steps.

### Related to Examples 1 to 4 and Comparative Examples 1 and 2

### <Step of Preparing Metal Magnetic Particles>

First, Fe10Ni20Co particles having D50 particle sizes of 0.19 μm, 0.40 μm, 0.85 μm, 1.85 μm, 3.10 μm, and 4.80 μm were provided. Next, a sol-gel process was performed in which a slurry was prepared by mixing Al alkoxide with a solvent (water) and the alkoxide in the slurry was hydrolyzed. The slurry was then dried to obtain metal magnetic particles having the surfaces thereof covered with a sol-gel coating film containing Al. The film thicknesses were about 10 nm or more and 20 nm or less (i.e., from 10 nm to 20 nm).

### <Step of Preparing Metal Magnetic Paste>

After the preparation of the metal magnetic particles, the metal magnetic particles were mixed with a varnish and terpineol as a solvent using a stirrer. The mixtures were then dispersed in a roll mill to obtain metal magnetic pastes.

### <Step of Preparing Insulating Paste>

Nonmagnetic insulating particles of alumina and borosilicate glass having a D50 particle size of about 0.1 to 0.5 μm were provided. These insulating particles were then mixed with a varnish and terpineol as a solvent using a stirrer. The mixture was then dispersed in a roll mill to obtain an insulating paste.

### <Step of Preparing Wiring Paste>

Copper particles having a D50 particle size of about 1 to 5 μm were mixed with a varnish and terpineol as a solvent using a stirrer. The mixture was then dispersed in a roll mill to obtain a wiring paste.

### <Step of Preparing Unfired Multilayer Body>

After the preparation of the individual pastes, a metal magnetic layer having a predetermined thickness was formed by screen printing using each metal magnetic paste and was dried. After drying, a slit groove having a predetermined width was formed by laser processing and was filled with the insulating paste by screen printing or the like, and the insulating paste was dried.

After the filling of the slit groove with the insulating paste and drying, an insulating layer having a predetermined thickness was formed on the metal magnetic layer by screen printing using the insulating paste and was dried.

Wiring having the desired shape was formed on the insulating layer by screen printing using the wiring paste. The formation of the metal magnetic layer and the formation of the insulating layer as described above were performed to obtain an unfired multilayer body.

<Step of Cutting into Piece and Firing Unfired Multilayer Body>

The unfired multilayer body was cut into a piece using a dicer or the like. The piece was then debinded in a nitrogen atmosphere in a firing furnace, followed by firing in a reducing atmosphere containing 3% of H₂ and 97% of N₂ at 1,000° C. for 90 minutes. Thus, a sintered body including a plurality of metal magnetic particles in particle form with a high-resistivity portion formed in a grain boundary phase between the metal magnetic particles was obtained.

### <Formation of Outer Electrodes>

Subsequently, the outer surface of the sintered body was coated with an insulating resin, and the coating was removed from regions where the wiring was to be connected to outer electrodes using a laser. The sintered body was then plated to form outer electrodes. Thus, an electronic component is obtained. The material for the outer electrodes can be, for example, silver.

Table 1 presents actual measurement data and determination results for sintered materials actually produced by sintering the metal magnetic pastes prepared in <Step of Preparing Metal Magnetic Particles> and <Step of Preparing Metal Magnetic Paste> described above in the same manner as above. The following determination criteria were set as the target characteristics: no heterophase other than the oxide of the metal (here, Al) used for the sol-gel coating film formed in the grain boundary phase, and the particle size (equivalent circle diameter) of the metal magnetic particles surrounded by the high-resistivity grain boundary phase was smaller than the skin depth at 200 MHz. Samples satisfying these determination criteria were determined as good (appropriate) in comprehensive determination.

TABLE 1
Measurement Results 1

| | Comparative | | | | | Comparative |
|---|---|---|---|---|---|---|
| | Example 1 | Example 1 | Example 2 | Example 3 | Example 4 | Example 2 |
| Equivalent circle | 0.14 | 0.29 | 0.62 | 1.36 | 2.33 | 3.79 |
| diameter of metal | | | | | | |
| magnetic particles | | | | | | |
| (μm) | | | | | | |
| High frequency | Good | Good | Good | Good | Good | Poor |
| compatibility | | | | | | *larger than |
| determination | | | | | | skin depth |
| | | | | | | at 200 MHz |
| Heterophase | Heterophase | No | No | No | No | No |
| determination | (iron oxide) | abnormality | abnormality | abnormality | abnormality | abnormality |
| | formed | | | | | |
| D50 particle | 0.19 | 0.4 | 0.85 | 1.85 | 3.1 | 4.8 |
| size of metal | | | | | | |
| magnetic particles | | | | | | |
| used (μm) | | | | | | |
| Comprehensive | Poor | Good | Good | Good | Good | Poor |
| determination | | | | | | |

The calculation of “skin depth” above was performed based on the equation [skin depth=(1/(π×σ×f×μ0×μr))\hat{ }0.5], where the relative magnetic permeability μr of the metal magnetic particles, namely, Fe10Ni20Co, is 70, the conductivity σ is 2.08×10⁶ (S/m), μ0 is the vacuum magnetic permeability, and f is the frequency. The skin depth at 200 MHz was calculated to be 2.95 μm.

The equivalent circle diameter of the metal magnetic particles in the sintered bodies was calculated by the following process. Specifically, each fired sample was placed in liquid resin and the resin was cured, was polished with a Tegramin-25 polishing device (manufactured by Struers), and was subjected to ion milling with an IM-3000 ion milling device (manufactured by Hitachi High-Technologies Corporation). An SEM image and optionally an element mapping image were then acquired under an SU8230 field-emission scanning electron microscope (manufactured by Hitachi High-Technologies Corporation). The imaging magnification was adjusted in the range of 3,500 to 60,000 times.

These acquired images were analyzed with WinROOF 2021 image analysis software (manufactured by Mitani Corporation) to calculate the equivalent circle diameter. In the analysis, the equivalent circle diameter was calculated as the average of analysis values for 20 randomly selected particles per position at three randomly selected positions near ½ of the thickness of a sintered toroidal core, that is, a total of 60 particles at three positions. When the finally obtained electronic component was used for calculation, the equivalent circle diameter was calculated as the average of analysis values at a total of six positions including three randomly selected positions located 1 time the wiring thickness upward from the uppermost surface of the inner wiring and three randomly selected positions located 1 time the wiring thickness downward from the lowermost surface of the inner wiring, that is, a total of 120 particles.

In addition, the following technique can be used to visualize that the grain boundary phase is a high-resistivity grain boundary phase. Specifically, each fired sample was placed in liquid resin and the resin was cured, was polished with a Tegramin-25 polishing device (manufactured by Struers), and was then processed into a shape suitable for the subsequent scanning probe microscope (SPM) measurement by focused ion beam (FIB) processing. The processed sample was finally cleaned by Ar flat milling.

This processed sample was used to measure spreading resistance in the scanning spread resistance microscope (SSRM) mode of the SPM. In the SSRM mode, a conductive probe was scanned across the sample while a bias voltage was being applied thereto, and the current flowing at each point was converted into a resistivity value to visualize the high-resistivity grain boundary phase. Although the high-resistivity grain boundary phase was determined as a portion with a resistivity value of 10\hat{ }3 times or more the maximum measured resistivity value of the metal magnetic particle portions, the threshold may be adjusted as appropriate with reference to the element mapping image such that the position of the high-resistivity grain boundary phase matches the position of a high-resistivity substance such as an oxide or a nitride.

The above results suggest that, in Comparative Example 1, an oxide of iron, which was a material for the metal magnetic particles, formed as a heterophase because the metal magnetic particles used had a small particle size and exhibited a high sintering shrinkage speed during firing and thus hindered entry of the reducing atmosphere gas into the inside. In addition, Comparative Example 2 was poor (inappropriate) in comprehensive determination because the metal magnetic particles used had a large particle size exceeding the skin depth at 200 MHz, which is, as described above, 2.95 μm.

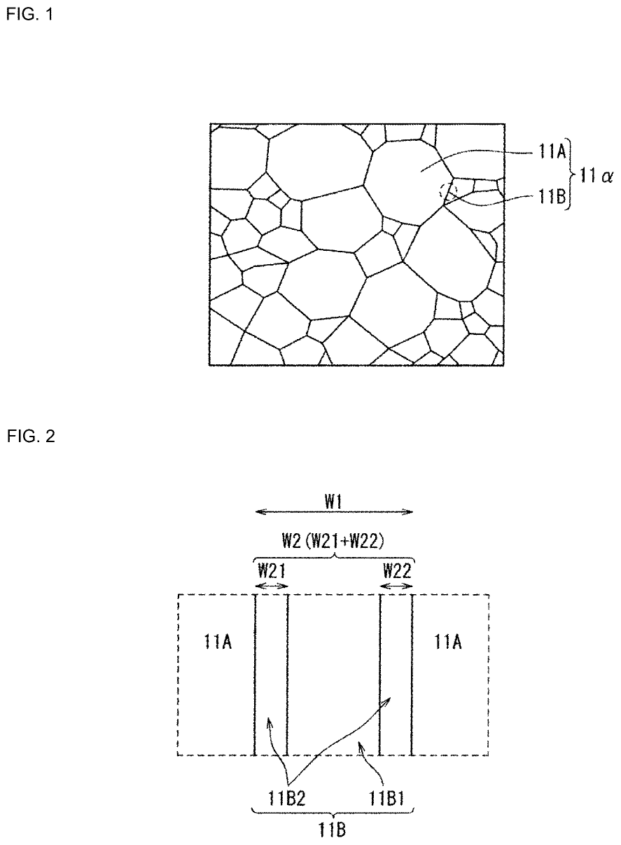

In contrast, in Examples 1 to 4, the metal magnetic particles had an equivalent circle diameter of 0.29 μm or more and 2.33 μm or less (i.e., from 0.29 μm to 2.33 μm). In this case, no heterophase other than Al oxide formed in the grain boundary phase, and the particle size (equivalent circle diameter) of the metal magnetic particles surrounded by the high-resistivity grain boundary phase was smaller than the skin depth (2.95 μm) at 200 MHz. Hence, the comprehensive determination was good (appropriate). In the present disclosure, a heterophase refers to an oxide of the metal magnetic particles. The presence of a heterophase decreases the saturation magnetic flux density of a sintered body. “Heterophase determination” for the oxide (e.g., iron oxide) of the metal magnetic particles was performed by the following procedure. Specifically, as illustrated in FIG. 2, it was determined that a heterophase was present when the minimum thickness W2 (W21+W22) of the oxide of the metal magnetic particles was larger than ⅔ of the width W1 of the grain boundary phase covering the entire metal magnetic particles 11A and located between the metal magnetic particles 11A.

The present disclosure includes the following forms, although the present disclosure is not limited to these forms.

<1> A magnetic material that is a sintered body including a plurality of metal magnetic particles having a grain boundary phase. The grain boundary phase contains a metal oxide or a metal nitride that is an oxide or a nitride of a nonmagnetic metal, and the metal magnetic particles have an equivalent circle diameter of 0.29 μm or more and 2.33 μm or less (i.e., from 0.29 μm to 2.33 μm).

<2> The magnetic material according to <1>, wherein the grain boundary phase contains an oxide of the metal magnetic particles.

<3> The magnetic material according to <1> or <2> wherein the plurality of metal magnetic particles contain Fe, and the metal oxide or the metal nitride is an oxide or a nitride of at least one metal selected from the group consisting of Si, Al, Cr, Ca, Mg, Ti, Mn, V, Zr, Nb, and Ta, the at least one metal being an element that oxidizes more easily than Fe.

<4> An electronic component including an element body including the magnetic material according to any one of <1> to <3> and wiring.

<5> The electronic component according to <4>, wherein the electronic component is an inductor.

<6> A method for producing a magnetic material, including forming a sintered body including a plurality of metal magnetic particles. A grain boundary phase is formed between the plurality of metal magnetic particles at least upon completion of sintering, the grain boundary phase containing a metal oxide or a metal nitride that is an oxide or a nitride of a nonmagnetic metal.

<7> The production method according to <6>, wherein the metal oxide or the metal nitride is an oxide or a nitride of at least one nonmagnetic metal selected from the group consisting of Si, Al, Cr, Ca, Mg, Ti, Mn, V, Zr, Nb, and Ta, the at least one nonmagnetic metal being an element that oxidizes more easily than Fe.

<8> The production method according to <6> or <7>, wherein surfaces of the metal magnetic particles are covered with a film containing the element that oxidizes more easily than Fe in advance before the sintering, and the metal magnetic particles covered with the film are sintered.

<9> The production method according to <8>, wherein the surfaces of the metal magnetic particles are covered with the film in two or more layers in advance.

<10> The production method according to any one of <6> to <9>, wherein metal magnetic particles containing Fe as a metal element and the element that oxidizes more easily than Fe are used, and the metal magnetic particles are sintered.

Although one embodiment of the present disclosure has been described above, the embodiment is merely given as a typical example in the range of application of the present disclosure. Therefore, a person skilled in the art will easily understand that the present disclosure is not limited thereto and various modifications can be made.

The electronic component according to the present disclosure can be used as an inductor.

What is claimed is:

1. A magnetic material comprising:
a sintered body including a plurality of metal magnetic particles having a grain boundary phase,
wherein
the grain boundary phase includes a metal oxide or a metal nitride that is an oxide or a nitride of a nonmagnetic metal, and
the metal magnetic particles have an equivalent circle diameter of from 0.29 μm to 2.33 μm.

2. The magnetic material according to claim 1, wherein
the grain boundary phase includes an oxide of the metal magnetic particles.

3. The magnetic material according to claim 1, wherein
the plurality of metal magnetic particles include Fe, and
the metal oxide or the metal nitride is an oxide or a nitride of at least one metal selected from the group consisting of Si, Al, Cr, Ca, Mg, Ti, Mn, V, Zr, Nb, and Ta, the at least one metal being an element that oxidizes more easily than Fe.

4. The magnetic material according to claim 1, wherein
a filling factor of the metal magnetic particles in the sintered body is from 66.7% to 95.1%.

5. An electronic component comprising:
an element body including the magnetic material according to claim 1, and wiring.

6. The electronic component according to claim 5, wherein
the electronic component is an inductor.

7. The magnetic material according to claim 2, wherein
the plurality of metal magnetic particles include Fe, and
the metal oxide or the metal nitride is an oxide or a nitride of at least one metal selected from the group consisting of Si, Al, Cr, Ca, Mg, Ti, Mn, V, Zr, Nb, and Ta, the at least one metal being an element that oxidizes more easily than Fe.

8. The magnetic material according to claim 2, wherein
a filling factor of the metal magnetic particles in the sintered body is from 66.7% to 95.1%.

9. The magnetic material according to claim 3, wherein
a filling factor of the metal magnetic particles in the sintered body is from 66.7% to 95.1%.

10. An electronic component comprising:
an element body including the magnetic material according to claim 2, and wiring.

11. An electronic component comprising:
an element body including the magnetic material according to claim 3, and wiring.

12. An electronic component comprising:
an element body including the magnetic material according to claim 4, and wiring.

13. A method for producing a magnetic material, comprising:
forming a sintered body including a plurality of metal magnetic particles,
wherein a grain boundary phase is formed between the plurality of metal magnetic particles at least upon completion of sintering, the grain boundary phase including a metal oxide or a metal nitride that is an oxide or a nitride of a nonmagnetic metal.

14. The method according to claim 13, wherein
the metal oxide or the metal nitride is an oxide or a nitride of at least one nonmagnetic metal selected from the group consisting of Si, Al, Cr, Ca, Mg, Ti, Mn, V, Zr, Nb, and Ta, the at least one nonmagnetic metal being an element that oxidizes more easily than Fe.

15. The method according to claim 13, wherein
surfaces of the metal magnetic particles are covered with a film including an element that oxidizes more easily than Fe in advance before the sintering, and the metal magnetic particles covered with the film are sintered.

16. The method according to claim 15, wherein
the surfaces of the metal magnetic particles are covered with the film in two or more layers in advance.

17. The method according to claim 13, wherein
metal magnetic particles including Fe as a metal element and the element that oxidizes more easily than Fe are used, and the metal magnetic particles are sintered.

18. The method according to claim 14, wherein
surfaces of the metal magnetic particles are covered with a film including an element that oxidizes more easily than Fe in advance before the sintering, and the metal magnetic particles covered with the film are sintered.

19. The method according to claim 14, wherein
metal magnetic particles including Fe as a metal element and the element that oxidizes more easily than Fe are used, and the metal magnetic particles are sintered.

20. The method according to claim 15, wherein
metal magnetic particles including Fe as a metal element and the element that oxidizes more easily than Fe are used, and the metal magnetic particles are sintered.
